(19) United States
(12) Patent Application Publication
(10) Pub. No.: US 2008/0091523 A1
(43) Pub. Date: Apr. 17, 2008

(54) Computer readable medium with instructions for recovering acquisition cost

(76) Inventors: Huy Ngoc Phan, Fort Worth, TX (US); Linh Ngoc Phan, Fort Worth, TX (US)

Correspondence Address: BUSKOP LAW GROUP, P.C., 4511 Dacoma Street, HOUSTON, TX, 77092, US

(21) Appl. No.: 11/580,351

(22) Filed: Oct. 13, 2006

(51) Int. Cl. G06Q 30/00

(52) U.S. Cl. 705/14

(57) ABSTRACT

A computer readable medium having stored thereon a plurality of instructions, the plurality of instructions include instructions which when executed by the company, the client, or a third party, cause the processor to perform a method for recovering acquisition cost wherein a company is engaged by a client to provide marketing media having a set acquisition cost, a recovery amount, and a recovery condition. The company performs or delivers the marketing media consistent with the acquisition agreement. At least two different audits are performed to determine whether the marketing media were successfully delivered, and the recovery condition was met prior to the return of the recovery amount to the client.

### FIELD

The present embodiments relate generally to a computer readable medium with instructions stored, which when activated by the company, the client, a third party, or combination thereof causes the processor to execute or perform a series of steps to recover acquisition costs for marketing media.

### BACKGROUND

There exists a need to help businesses manage effective and risk free marketing campaigns or marketing spending at the lowest possible cost.

With rising marketing costs and a fast-paced hi-tech environment, business owners must find a way to stay ahead of the competition and to be able to compete financially without overspending on marketing products and services.

A need has existed for a computer program that enables the recovery of acquisition costs, which include the costs to buy, rent, or lease products, services, or delivery medium of such products and services based on use of different kinds of goals and media.

There exists a need to help businesses to increase profit margin by reducing marketing expenditure.

There exists a need to help businesses to sustain growth and competitiveness by effectively allocating funding into crucial areas, such as research and development, by reducing marketing cost.

There exists a need to help start-up businesses to establish their brands in the beginning by effectively marketing their products and services without the constraint of marketing spending.

There exists a need to help non-profit organizations or political parties to communicate effectively with the public at minimal cost.

There exists a need to eliminate marketing frauds such as computer pay-per-click fraud, or falsely report of marketing statistical data etc. that can quickly deplete company marketing budget.

The present embodiments meet these needs.

### BRIEF DESCRIPTION OF THE DRAWINGS

The detailed description will be better understood in conjunction with the accompanying drawings as follows:

FIG. 1 depicts an embodiment of the instructions usable by a processor within the scope of the invention.

FIG. 2 depicts an illustration of a computer system usable to execute the instructions on computer readable media.

The present embodiments are detailed below with reference to the listed Figures.

### DETAILED DESCRIPTION OF THE EMBODIMENTS

Before explaining the present embodiments in detail, it is to be understood that the embodiments are not limited to the particular embodiments and that they can be practiced or carried out in various ways.

The invention relates to computer readable media having stored thereon a plurality of instructions, which when activated by the company, the client, a third party, or combination thereof causes the processor to execute or perform a series of steps to recover acquisition costs for marketing media, that includes, as part of the method use of a defined marketing media needed, marketing media cost, a recovery amount, and a recovery condition.

It should be noted that the term “acquisition cost”, as used herein is the cost paid by the client to a company for the purchasing marketing media.

The acquisition costs of marketing media can include but are not limited to, setup and disposal costs, material costs, construction costs, labor costs, design costs, bandwidth costs, hosting costs, delivery and display costs, operating costs, hardware and software costs, advertising costs, advising and consulting costs, insurance costs, penalty costs (if the agreement between client and company is breached), delivery medium costs, including but not limited to a variety of other types of cost directly related to buying media.

The term “marketing media” as used herein, encompasses the following: marketing product(s), marketing service(s), marketing concept(s), delivery medium(s), or any combinations thereof.

The term “recovery amount” as used herein is defined as a portion (less than 100%), or a full amount (100%), or more than 100%, such as up to 500%, or any predetermined amount, which was agreed upon between the company, the client, a third party, or combinations thereof when the engagement was initiated, which is returned back to the client when the sequence of steps used in the invention are followed.

For example, a client pays $1 million dollars to the company to display an advertisement 10 millions times on a website. The recovery condition is that on the last day of the 12^{th} month a recovery amount of $1 million is returned back to the client.

The term “recovery condition” can be one, or any combination, of the following:
(1) A payment date;
(2) Meeting or exceeding a minimum amount of acquisition cost;
(3) The occurrence of an event;
(4) The occurrence of a series of events;
(5) Successful delivery of the marketing media; or
(6) Expiration of a period of time for use of a delivery medium; or similar other events.

When one or any combination of the events noted above occurs, a recovery amount of the acquisition cost is returned to the client.

The term “payment date” as used herein can refer to, but is not limited to, any specific point in time such as: a second; a minute; a hour; a day; a week; a month; a year; a decade; an event; or any arbitrary unit of time that has no correlation to the actual calendar, which is used as a quantifiable measure to determine the recovery condition.

An example for each case is illustrated below:

(1) Specific Payment Date: The recovery amount is returned to the client on the 365^{th} day after the campaign's start date.

(2) Meeting or Exceeding a Minimum Amount of Acquisition Cost: The percentage of the recovery amount is returned to the client based upon the amount of acquisition cost contributed. For example in order to get back a full 100% of the acquisition cost, or more than 100%, such as 400% or 500%, the client is required to purchase $100,000 dollars or more of marketing media.

(3) An Event: The recovery amount is returned to the client when the client's company stock is below $12 per share.

(4) A Series of Events: The recovery amount is returned to the client when the client successfully sold 10,000 products as projected, and a merger between the client and another company has occurred.

(5) Successful Delivery of the Marketing Media: The recovery amount is returned to the client when the number of ad exposures successfully reached 10 millions exposures.

(6) Expiration of Delivery Medium: The recovery amount is returned to the client when the usage of a broadcasting station or a video-sharing website reached the end of the third year.

The computer readable medium with instructions stored thereon is used by a client, the company, a third party or any combination thereof to support the client's objective(s). An example of a client's objectives is to promote the client's brand(s). Another example of a client's objectives is to promote the client's products, services, concepts, or any combination thereof.

The invention can be best understood with reference to the Figures.

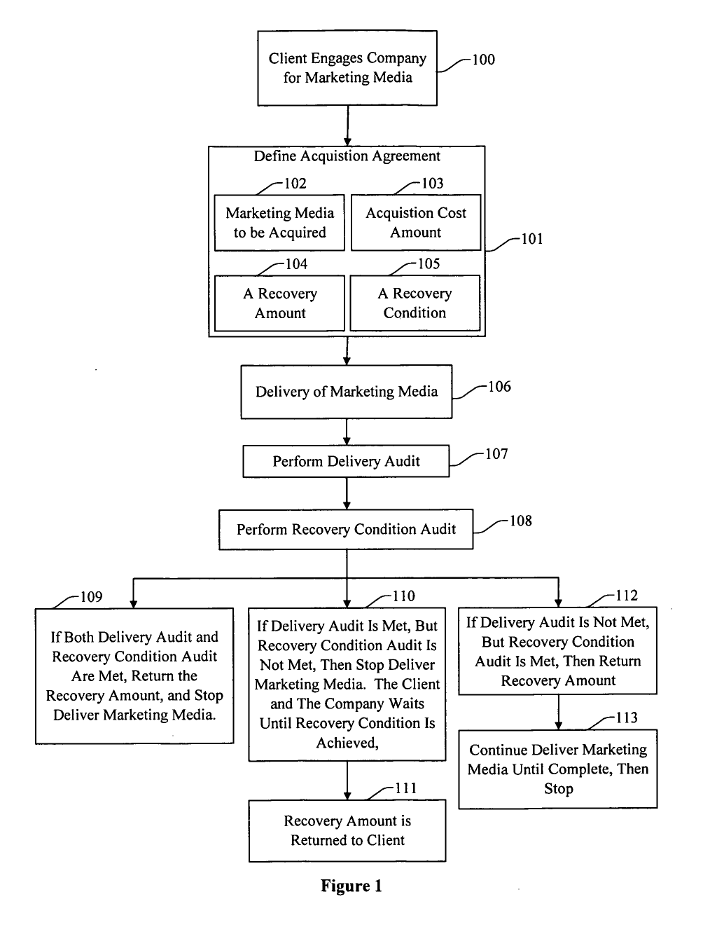

Referring to FIG. 1, the first element, Element 100, of the method involves the client engaging the company for marketing media. The engagement step can include the drafting of an agreement or contract to define the relationship between the parties including the details of the recovery condition and the recovery amount.

The engagement step includes defining and identifies all participating parties involved such as but not limited to the client, the company, a third party, or any combination thereof. A third party can be an insurance institution, like State Farm, a bank, a financial institution, such as a stock trading company, like Schwab, a legal advising entity such as a law firm, or a similar service provider, such as an accountant.

The next step of the method, Element 101, involves the client, the company, and a third party, or any combination thereof, defining the following terms in the agreement:
a. The marketing media to be acquired, delivered, performed, or a combination of these items, Element 102;
b. An acquisition cost, Element 103;
c. A recovery amount, Element 104; and
d. A recovery condition shown as Element 105.

Once an acquisition of marketing media, an acquisition cost, a recovery amount, and a recovery condition are agreed upon, the next step shown as Element 106 is initiated.

Element 106 involves the delivery of the marketing media, which can be products, services, concepts, or delivery medium by the company or a third party to the client.

Element 107 shows that the company performs a delivery audit to determine whether the marketing media was successfully delivered, and a recovery condition audit, Element 108, which is performed to determine whether the recovery condition shown as Element 105 was met or not.

If both audits (Element 107 and Element 108) indicate that the delivery of marketing media and the recovery condition was met, then the delivery of marketing media is stopped, and the agreed upon recovery amount is returned to the client as depicted in Element 109. The audits are performed using a processor and computer instructions on computer readable media instructing the processor to perform the steps of the audit to verify that delivery has been achieved and the recovery condition has been met. The processor can be a laptop, PC or other wireless processing device like a laptop on using a website connected to a server that is accessible via the Internet.

The recovery amount can be returned by wire transfer, by bank transfer, by check, by unmarked bills, by cash, by credit, or any symbolic fund, trading, bartering, which can be equated to monetary value that the client has agreed with the company as a method of payment.

If the marketing media was successfully delivered, but the recovery condition audit shows that the recovery condition 105 was not met, then the method proceeds to the step shown as Element 110, wherein the delivery of the marketing media is stopped. The client and the company then wait until the recovery condition is achieved, then the recovery amount is returned to the client, Element 111.

If the marketing media was not successfully delivered as determined by the audit of Element 107, yet the recovery condition was successful according to the audit of Element 108, then the recovery amount 104 is returned to the client as shown in the step of Element 112. Then the step shown in Element 113 occurs, wherein the company continues to deliver the marketing media until it is fully delivered as shown by one or more additional delivery audits performed by the company. Then delivery of the marketing media is stopped.

The term “acquisition cost” used can be a fee that is paid using cash, check, credit, bank transfer funds, or any symbolic funds, trading, or bartering, which can be equated to a monetary value that the client agreed to pay the company, or to invest into the company, or to deposit into a third-party account for the purpose of purchasing media.

An acquisition of marketing media is defined as an acquisition of marketing products, marketing services, or marketing concept, which can be a purchase of a number of exposures; or a number of visits to the client's websites or physical business locations; a purchase of exposure resulting in a number of client's products, services, or memberships sold; a number of marketing item giveaways; a number of visits to events; a number of flyers, handouts, prints, publications; or a marketing target such as, an amount of profit, an amount of cash, a number of credits, a percentage of population, or a number of events; a duration of marketing services in seconds, minutes, hours, days, weeks, months, years, decades; or the time invested in creating marketing campaigns, concepts, slogans, artworks, presentations, flyers, handouts, prints, publications; or any combinations thereof.

An acquisition of the delivery medium is defined as a purchase or total rights, or purchase of partial rights, or a lease of a partial rights or a full exclusive rights to utilize a channel or a network of channels, such as but not limited to, a website, a physical location, a TV station, a radio station, a transportation channel, an individual, a media content delivery company, or any company that has the capability or expertise to perform mass communication.

The term “client” is defined as, but is not limited to, any number of the groups, which have a need to communicate or acquire marketing media.

A “client” can be an individual, a group of individuals, a business, an association, an organization, a non-profit organization, a political party, a partnership, a corporation, an agency, a professional society, an other online business entity, an offline business entity, or any combinations thereof.

The term “company” is defined as, but is not limited to, any number of groups, which have the marketing mediums, or the media capability, or the expertise to prepare, create, provide, communicate, or deliver marketing media.

The “company” can be an individual, a group of individuals, a business, an association, an organization, a non-profit organization, a political party, a partnership, a corporation, an agency, professional society, an ad content delivery company, an other online business entity, an offline business entity, a third party or a group of parties associated with the company, any entity that has the capability or expertise to perform mass communication, or any combinations thereof.

“Marketing media” can be one or more of the following online embedded marketing means, such as but not limited to: online e-mail marketing, online incentive marketing, online products marketing, online discounts for products and services marketing, online services marketing, online personal-ad marketing, online search engine marketing, online news marketing, online banners marketing, online pop-ups marketing, online maps marketing, online information and blogs marketing, online image marketing, online text marketing, online audio marketing, online video marketing, online syndication marketing, or any combinations thereof.

The term “online”, as the term is used herein, refers to but is not limited to electronic communication via a public network, such as the Internet or a private network, such as AOL, Local Area Network (LAN), Wide Area Network (WAN), Metropolitan Area Network (MAN), Storage Area Network (SAN), System Area Network (SAN), Server Area Network (SAN), Small Area Network (SAN), Personal Area Network (PAN), Desk Area Network (DAN), Controller Area Network (CAN), Cluster Area Network (CAN), or combinations thereof.

Syndication marketing is a form of syndication in which a section of an advertising space is made available for others to use for the purpose of marketing. A form of syndication marketing is RSS (Really Simple Syndication), which is a method that quickly gathers and displays information, images, text, audio, video from multiple sources.

Embedded marketing is a form of marketing wherein actual products, services, concepts, or brands are purposefully displayed in movie, television, website, broadcast, lyrics, newspaper, magazine articles, and other kinds of mass communications for the purpose of marketing.

“Marketing media” can also be radio ad creation and placement. A marketing message is selectively communicated using, satellite broadcasts, AM frequency broadcasts, FM frequency broadcasts, cable TV broadcasts, and public or private network broadcasts, or any combinations thereof.

The radio ad marketing message; can include creation of unique marketing ads; embedding a marketing message in lyrics; embedding a marketing message in music; embedding marketing messages in specific topics; targeted discussion; or targeting a marketing message to specific products, services, or groups.

“Marketing media” can also be television commercial creation and placement wherein a marketing message is selectively created, and is selectively communicated by using a marketing ad campaign; a banner broadcasted on a television screen; a slogan broadcasted on a television screen; a musical broadcasted on a television screen; a play broadcasted on a television screen; lyrics of a song broadcasted on a television screen; infomercials broadcasted on a television screen; spot marketing broadcasted on a television screen; TV show embedding marketing; TV syndication marketing; video embedding marketing; video game embedding marketing; video cassette movie embedding marketing; digital video disc movie embedding marketing; cable TV; network TV; Web-TV marketing; and any combinations thereof.

An example of television commercial creation and placement is selectively creating a marketing message by creating a slogan that employs the use of musical lyrics and selectively communicating the message by broadcasting it during prime time network television.

“Marketing media” can also be electronic or non-electronic mobile public marketing displays. Wherein, the electronic or non-electronic mobile public marketing can be the actual vehicles, or a marketing message selectively displayed on any part of a commercial vehicle; a non-commercial vehicle; a public transportation; a rental vehicle; a bus; a taxi; a boat; a ship; a jet ski, a vehicle that runs on tracks or monorails, such as a train, a trolley, a rollercoaster; an automobile; a snowmobile; a recreational vehicle; a sports utility vehicle; a truck; a van; a bicycle; a stroller; a motorcycle; a scooter; an airplane; a livestock, a banner pulled by aircraft; a racecar, a lighter than air vehicle; a vehicle capable of traversing outer space or undersea; and any combinations thereof.

An example of an electronic or non-electronic mobile public marketing can be, selectively displaying a marketing message, such as a picture of a client's product with a slogan, upon a vehicle, such as, a public bus, wherein the message can be selectively displayed upon the interior or exterior of the bus.

“Marketing media” can be electronic or non-electronic stationary public marketing displays including but not limited to the physical product itself, or a marketing message selectively displayed on a billboard; a sign; a movie theater screen; a poster; a banner; a flag; a retail store display screen; a sport arena display screen; a recreational arena display screen; a restaurant display screen; a restaurant menu; on restaurant and hotel furniture; on any part of the restaurant, hotel, or rental property; a gaming and entertainment station; a hospitality display screen; a commercially projected screen; an umbrella; a bench; a stair case; a restroom; an interactive urinal communicator; a telephone or information booth; a water fountain; a waiting area; a break area; a beverage and snack vending machine; a multi-products dispenser machine (petroleum products, electronic products, toys, candies etc.); a transportation station area; a rest stop area; a refueling station; a bridge; a swimming pool; a recreational arena; a park; a building; a residential building; a fence; a rail; a road; a street; a highway; a toll-way; a parking spot; a parking lot; a parking garage; an other large visible structure or area, such as but not limited to a telephone pole, an open field, the sky; the ocean, and any combinations thereof.

“Marketing media” can be electronic or non-electronic personal mobile multi-function interactive marketing means, including but not limited to the product itself, or a marketing message selectively communicated using a wireless mobile device, such as a cell phone; a camera; a global positioning system, a mobile video display; a mobile music player; a laptop; a Bluetooth®; a personal digital assistant (PDA); a Blackberry™; a pager; a MP3 player; a MP4 player; a video game; and other portable electronic device; a toy; a stroller; a shirt; a uniform; a pair of pants; an undergarment; an other garment; a tattoo; a temporary tattoo; a purse; a wallet; a handbag; a make-up accessory; a towel; a watch; an umbrella; a piece of sports equipment, uniform, and tools; a hat; a helmet; a headband; a wristband; a pair of sunglasses; a pair of eyeglasses; a pair of goggles; a pair of gloves; a mask; a suit; a jacket; a pair of shoes, boots, flip flop; a piece of recreational gear, uniform, and tools; a piece of luggage; a suitcase; a lunch bag; a set of playing cards; a business card; a box; a bottled beverage; a consumable and non-consumable product; a restaurant condiment package; a napkin; a tray; a cup; a coaster; wrapping paper; an office supply product; a pen; a pencil; an eraser; a notebook; a mouse pad; a personal computing product; a livestock; and any combinations thereof.

An example of an electronic or non-electronic personal mobile multi-function interactive marketing means is an event announcement selectively communicated to the public by sending a text message on a mobile phone.

Another example, is where a multi-function interactive service provider delivers a coupon in real-time onto a person's cell-phone screen as the person walks by the store, which offers the coupon.

“Marketing media” can also be viral marketing means, can include hiring a public speaker; hiring a person with a marketing sandwich; creating surveys and hiring surveyors to perform the surveys; locating and contracting for celebrity, athletes, political figure endorsements; marketing at a trade show; marketing at a live show; marketing at a live event; locating and contracting for concert band endorsements; marketing on a customer's artwork; marketing using body arts; marketing in graffiti; marketing on livestock or domestic animals; marketing by imprinting on sands, beaches, turfs; marketing on blogs; marketing in media; marketing in digital media; marketing with instant messaging; marketing by sponsorship; sending out chain e-mails; creating a controversial debate; participating in Internet Relay Chatting (IRC); marketing on a Bluetooth®; embedding a marketing message in music lyrics; embedding a marketing message in movie plots; embedding a marketing message in novel plots; embedding a marketing message in game plots; participating in multi-level marketing; arranging personal meetings or net meeting; participating in seminars; performing lectures; participating in demonstrations; marketing by word-of-mouth; targeting advertisements toward certain products, services, groups; and any combinations thereof.

“Marketing media” can include the marketing services that promote a brand, a product, a service using contests or games. The term “contests”, as referred to herein, includes a lottery game, a sweepstake, a contest game, a celebrity game, an online game, an off-line game, an other type of game, and any combinations thereof.

“Marketing media” can also be printed and recordable marketing media such as the actual printed and recordable product itself, or selectively communicating a marketing message by selectively using periodicals, personal letters, books, newspapers, napkins, stickers, temporary tattoo, consumable products, coasters, cups, bottles, containers, trays, wrapping paper, toilet paper; toys, musical instruments, direct mail, customer payment receipts, business cards, free standing inserts, flags, banners, yellow pages, white pages, other phone books, flyers, calendars, personal classified ads, folders, posters, compact discs (CDs), digital video discs (DVD), solid-state recordable medium, promotional items, commercial packaging, non-commercial packaging, computer peripheral, livestock, domestic animals, and any combinations thereof.

An example of selectively communicating a marketing message in print or other recordable media can be displaying a picture of a specific product accompanied by a sales slogan in a popular magazine.

Any combination of the marketing media above can be included in the acquisition of marketing media.

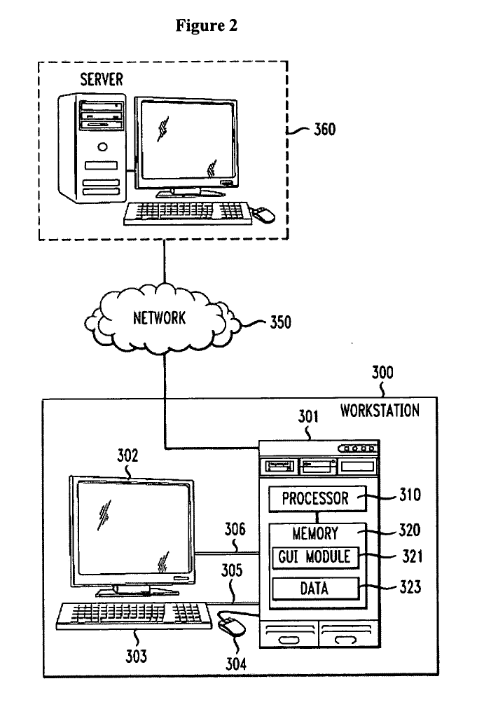

It is additionally contemplated that the computer instructions can be embodied into a computer system as depicted in FIG. 2, which is an illustration of a computer system to perform the embodied methods.

FIG. 2 shows a workstation 300 including a computer 301, which can be coupled to a video display 302 via an external graphics bus 306.

The external graphics bus 306 can be an Advanced Graphics Port (AGP) compliant bus. The term “coupled” as used herein encompasses a direct connection, an indirect connection, or the like.

Computer 301 in an embodiment includes a processor 310, such as the Pentium™ processor manufactured by Intel Corp. of Santa Clara, Calif. In another embodiment, the processor 310 can be an Application Specific Integrated Circuit (ASIC). Computer 301 can include a memory 320 coupled to the processor.

Memory 320 encompasses devices adapted to store digital information, such as Dynamic Random Access Memory (DRAM), Rambus™ DRAM (RDRAM), flash memory, a hard disk, an optical digital storage device, a solid-state storage device, a combination thereof, etc.

The computer 301 can be coupled to a keyboard 303 and a mouse 304 via an external computer bus 305. In one embodiment, the external computer bus 305 is a Universal Serial Bus (USB) compliant bus.

Memory 320 can include computer instructions adapted to be executed by the processor 310 to perform a method in accordance with an embodiment of the present invention.

The term “computer instructions adapted to be executed” by a processor includes computer instructions that are ready to be executed in machine language by a processor, or are computer instructions that require further manipulation (for example, compilation, decryption, decoding, or provided with an access code) to be ready to be executed by a processor 310.

In one embodiment, the memory 320 can include a graphical user interface (GUI) module 321 to implement a graphical user interface for use by a user.

In another embodiment, the workstation 300 is coupled to a server 360 via a network 350, and the server 360 has a processor 380 and a memory 390. Memory 390 can include instructions adapted to be executed by the processor 380 to perform a method in accordance with embodiment of the present invention.

Examples of network 350 include the internet, Local Area Network (LAN), Wide Area Network (WAN), Metropolitan Area Network (MAN), Storage Area Network (SAN), System Area Network (SAN), Server Area Network (SAN), Small Area Network (SAN), Personal Area Network (PAN), Desk Area Network (DAN), Controller Area Network (CAN), Cluster Area Network (CAN), or a communications network, a computer network, or any combination thereof, etc.

In an embodiment, the server 360 is coupled to a storage device 361 that typically stores data on magnetic medium such as a magnetic disk, a solid-state storage device, or an optical storage device.

The storage device 361 may store application programs and associated data files and or documents. Examples of documents include word processing documents, spreadsheet documents, HTML (Hypertext Markup Language) documents, graphics, video, audio data and the like.

Workstation 300 can access data stored in the storage device 361 via server 360 and network 350.

In an embodiment, server 360 can display information on display 302 by sending information signals to workstation 300 via network 350. Examples of display information include data a GUI component, a web page, and the like.

The storage device 361 can contain data 323 can encompass hierarchical data, non-hierarchical data, and the like. Data 323 can be a document corresponding to a particular application such as a word processing document, a spreadsheet document, an HTML document, and the like.

Computer instructions adapted to be executed by a processor to perform the embodied methods are stored on a computer-readable medium and distributed as software.

The computer-readable medium can be a device that stores digital information. For example, a computer-readable medium includes software program that can be transferred through a public or private network, a portable magnetic disk, such as a floppy disk; a portable solid-state memory device; or a Zip™ disk, manufactured by the Iomega Corporation of Roy, Utah (Zip™ is a registered trademark of Iomega Corporation); or a Compact Disk Read Only Memory (CD-ROM); or a Digital Video Disc (DVD), computer peer-to-peer communication is known in the art for distributing software. The computer-readable medium can be distributed to a user that has a processor suitable for executing instructions adapted to be executed by the use of a network.

An embodiment of the invention contemplates that at least one of the audits can be repeated or revised during the course of the engagement of the company by the client to shorten the time period for performing or delivering of the marketing media.

The audit is preferably performed by the company, but can be performed by the client, a third party, or a combination of both.

An embodiment of the method contemplates that the recovery amount can be any predetermined amount, which was agreed upon between the company, the client, a third party, or combinations thereof when the engagement was initiated, which is returned back to the client.

The acquisition of marketing media can be for marketing campaigns, marketing products, marketing services, marketing concepts, or the delivery medium of such campaigns, products, services, and concepts. The marketing media can be an online or off line marketing.

While these embodiments have been described with emphasis on the embodiments, it should be understood that within the scope of the appended claims, the embodiments might be practiced other than as specifically described herein.

What is claimed is:

1. A computer readable medium having stored thereon a plurality of instructions, the plurality of instructions include instructions which causes the processor to execute or perform the method steps comprising:
a. forming an agreement with a term between a company, a client, a third party, or combinations thereof for marketing media, wherein the marketing media has an acquisition cost;
b. defining the marketing media needed by the client, by a third party, or combinations thereof;
c. determining an acquisition cost for the marketing media, a recovery amount for the client, and a recovery condition for providing the recovery amount by the company, a third party, or combinations thereof;
d. initiating delivery of the marketing media consistent with the acquisition agreement by the company, the processor, or a third party;
e. performing a delivery audit to determine whether the company delivered the indicated marketing media;
f. performing a recovery condition audit to determine whether the recovery condition is met;
g. when the delivery audit shows that the marketing media was successfully delivered and the recovery condition audit shows that the recovery condition was met, then delivery of the marketing media is stopped and the recovery amount is returned to the client;
h. when the delivery audit shows that the marketing media was successfully delivered, but the recovery condition audit shows that the recovery condition was not met, then the delivery is stopped, and the company and the client wait until the recovery condition is attained before the recovery amount is returned to the client; and
i. when the delivery audit shows that the marketing media was not successfully delivered, but the recovery condition audit shows that the recovery condition was met; the recovery amount is returned to the client, the delivery of the marketing media is continued until a subsequent delivery audit indicates that the marketing media has been successfully delivered, at which time delivery is stopped.

2. The computer readable medium of claim 1, further comprising instructions that the delivery audit and the recovery condition audit are repeated during the term of the agreement.

3. The computer readable medium of claim 1, further comprising instructions that the delivery audit and the recovery condition audit are performed by the company, by the client, by a third party, and combinations thereof.

4. The computer readable medium of claim 1, further comprising instructions that the company comprises a member of the group consisting of: an individual, a group of individuals, a business, an association, an organization, a non-profit organization, a political party, a partnership, a corporation, an agency, professional society, an ad content delivery company, an other online business entity, an offline business entity, a third party or a group of parties associated with this company, any entity that has the capability or expertise to perform mass communication, or combinations thereof.

5. The computer readable medium of claim 1, further comprising instructions that the client is an individual, a group of individuals, a business, an association, an organization, a non-profit organization, a political party, a partnership, a corporation, an agency, a professional society, an other online business entity, an offline business entity, and combinations thereof,

6. The computer readable medium of claim 1, further comprising instructions that the marketing media comprises: marketing products, marketing services, marketing concepts, delivery medium of such product, services, concepts, and combination thereof.

7. The computer readable medium of claim 1, further comprising instructions that the marketing media comprises:
a. online marketing media;
b. radio marketing media;
c. television marketing media;
d. stationary public marketing media;
e. mobile public marketing media;
f. personal stationary marketing media;
g. personal mobile marketing media;
h. viral marketing media;
i. marketing media using contests;
j. printed and recordable marketing media and combinations thereof.

8. The computer readable medium of claim 7, wherein the contests are a member of the group consisting of: a lottery game, a sweepstake, a contest game, a celebrity game, an online game, an off-line game, and other types of game, and combinations thereof.

9. The computer readable medium of claim 7, further comprising instructions comprising a member of the group consisting of: hiring a public speaker, hiring a person with a marketing sandwich, creating surveys, hiring surveyors to perform surveys, contracting for celebrity endorsements, marketing at a trade show, marketing at an event, marketing at a performance, contracting for concert band endorsements, inserting marketing in artwork, marketing, using graffiti as marketing, displaying marketing on livestock and domestic animals, displaying marketing by imprinting on sand, beaches, turf, marketing using blogs, inserting marketing in digital media, delivering marketing using instant messaging, sending out chain e-mails, creating a controversial debate, participating in Internet Relay Chatting (IRC), embedding a marketing message in music lyrics, embedding a marketing message in a movie plot, embedding a marketing message in a novel, embedding a marketing message in a game, participating in multi-level marketing, arranging personal meetings or net meeting, participating in seminars, performing lectures, marketing by word-of-mouth, and combinations thereof.

10. The computer readable medium of claim 7, further comprising instructions comprising periodicals, personal letters, books, newspapers, napkins, stickers, temporary tattoo, consumable products, coasters, cups, bottles, containers, trays, wrapping paper, toilet paper, toys, musical instruments, direct mail, customer payment receipts, business cards, free standing inserts, flags, banners, yellow pages, white pages, other phone books, flyers, calendars, personal classified ads, folders, posters, compact discs, digital video discs, solid-state recordable media, promotional items, commercial packaging, non-commercial packaging, computer peripheral, livestock, domestic animals, and combinations thereof.

11. The computer readable medium of claim 7, further comprising the instructions that the personal mobile multi-function interactive marketing media transmits a marketing message selectively using a member of the group: a wireless mobile device, a camera, a global positioning system, a mobile video display, a mobile music player, a laptop, a personal digital assistant, a pager, a MP3 player, a MP4 player, a video game, a toy, a stroller, a shirt, a uniform, a pair of pants, an undergarment, another garment, a tattoo, a temporary tattoo, a purse, a wallet, a make-up accessory, a towel, a watch, an umbrella, a piece of sports equipment, an uniform, tools, a hat, a helmet, a headband, a wristband, a pair of sunglasses, a pair of eyeglasses, a pair of goggles, a pair of gloves, a mask, a suit, a jacket, a pair of shoes, a pair of boots, a flip flop, a piece of recreational gear, a piece of luggage, a lunch bag, a set of playing cards, a business card, a box, a bottled beverage, a consumable and non-consumable product, a restaurant condiment package, a napkin, a tray, a cup, a coaster, wrapping paper, a pen, a pencil, an eraser, a notebook; a mouse pad, a personal computing product, a livestock or domestic animals, and combinations thereof.

12. The computer readable medium of claim 7, further comprising instructions that the mobile public marketing media is displayed on any part of a member of the group consisting of: commercial vehicle, a non-commercial vehicle, a public transportation, or a rental vehicle, a bus, a taxi, a boat, a ship, a jet ski, a vehicle that runs on tracks or monorails, a trolley, a rollercoaster, an automobile, a snowmobile, a recreational vehicle, a sports utility vehicle, a truck, a van, a bicycle, a stroller, a motorcycle, a scooter, an airplane, a farm animal, a banner pulled by aircraft, a racecar, a lighter than air vehicle, a vehicle capable of traversing outer space or undersea, and combinations thereof.

13. The computer readable medium of claim 7, further comprising instructions that the online marketing media comprises selectively communicating a marketing media using a member of the group consisting of: online email marketing, online incentive marketing, online products marketing, online discounts for products and services marketing, online services marketing, online personal-ad marketing, online search engine marketing, online news marketing, online banners marketing, online pop-ups marketing, online maps marketing, online information and blogs marketing, online image marketing, online text marketing, online audio marketing, online video marketing, online syndication marketing, or combinations thereof.

14. The computer readable medium of claim 7, further comprising instructions that the stationary public marketing media includes marketing media is the product itself, or selectively displayed on a member of the group consisting of: a billboard, a sign, a movie theater screen, a poster, a banner, a flag, a retail store display screen, a sport arena display screen, a recreational arena display screen, a restaurant display screen, a restaurant menu, on restaurant and hotel furniture, on restaurant and hotel window, a gaming and entertainment station, a hospitality display screen, a commercially projected screen, an umbrella; a bench, a stair case, a restroom, an interactive urinal communicator, a telephone or information booth; a water fountain, a waiting area, a break area, a beverage and snack vending machine, a multi-product dispenser machine, a transportation station area, a rest stop area, a refueling station, a bridge, a swimming pool, a recreational arena, a park, a building, a residential building, a fence, a rail, a road, a street, a highway, a toll-way, a parking spot, a parking lot, a parking garage, another large visible structure, a telephone pole, an open field, the sky, the ocean, and combinations thereof.

15. The computer readable medium of claim 7, further comprising instructions that the radio marketing media comprises selectively communicating a marketing media using a member of the group consisting of: embedding a marketing media in lyrics, embedding a marketing media in music, embedding marketing media in specific topics, holding a targeted discussion on the radio, and any combinations thereof and broadcasting the marketing media using satellite radio, broadcasting over an AM frequency, broadcasting over a FM frequency, broadcasting over cable TV, broadcasting over a public network, or broadcasting over a private network.

16. The computer readable medium of claim 7, further comprising instructions that the television marketing media comprises selectively communicating a marketing media using a member of the group consisting of: a marketing ad campaign, a banner broadcast on a television screen, a slogan broadcast on a television screen, a musical broadcast on a television screen, a play broadcast on a television screen, lyrics of a song broadcast on a television screen, infomercials broadcast on a television screen, spot marketing broadcast on a television screen, TV show embedding marketing, TV syndication marketing, video embedding marketing, video game embedding marketing, video cassette movie embedding marketing, digital video disc movie embedding marketing, cable TV, network TV, Web-TV, or combinations thereof.

17. The method of claim 1, wherein the recovery amount of an acquisition cost is an amount agreed upon when the engagement was formed.

18. The computer readable medium of claim 1, further comprising instructions that the acquisition cost is the cost that the client agreed to pay the company, or to invest into the company, or to deposit into a third party account for the purpose of purchasing marketing media.

19. The computer readable medium of claim 1, further comprising instructions that the acquisition of marketing media is an acquisition of a marketing product, a marketing service, a marketing concept, a delivery medium or combinations thereof.

20. The computer readable medium of claim 1, further comprising instructions that the acquisition can be a member of the group consisting of: a purchase of a number of exposures, a purchase of a number of visits to a defined website, a purchase of a number of visits to a physical business location, a quantity of marketing item giveaways, a quantity of visits to events, a number of flyers, a number of handouts, a quantity of prints, a quantity of publication.

21. The computer readable medium of claim 1, further comprising instructions that the acquisition can be acquisition of a marketing target selected from the group consisting of: an amount of profit, an amount of cash, a number of credits, a percentage of population, or a number of events.

22. The computer readable medium of claim 1, further comprising instructions that the acquisition is by purchase of a right to use a channel, by lease of a partial right to utilize a channel, or by lease of an exclusive right to utilize a channel.

23. The computer readable medium of claim 22, further comprising instructions that the channel be a system of channels to perform or deliver mass communication.

24. The computer readable medium of claim 1, further comprising instructions that the recovery condition is a member of the group consisting of: a specific payment date, meeting or exceeding a minimum amount of acquisition cost, holding of an event, holding of a series of events, successful delivery of marketing media, an expiration date for use of a delivery medium, or combination thereof.
